(19) United States
(12) Patent Application Publication
(10) Pub. No.: US 2025/0001901 A1
(43) Pub. Date: Jan. 2, 2025

(54) UNIT AND METHOD FOR DETERMINING AN ELECTRICAL REMAINING UTILIZATION CAPACITY OF AN ENERGY SUPPLY SOURCE OF A ROAD CONSTRUCTION MACHINE

(71) Applicant: Joseph Vögele AG, Ludwigshafen/Rhein (DE)

(72) Inventors: Steffen KOST, Bad Dürkheim (DE); Bernhard ERDTMANN, Edingen Neckarhausen (DE)

(73) Assignee: Joseph Vögele AG, Ludwigshafen/Rhein (DE)

(21) Appl. No.: 18/754,300

(22) Filed: Jun. 26, 2024

(30) Foreign Application Priority Data
Jun. 27, 2023 (EP) 23181669.5

(51) Int. Cl. B60L 58/12

(52) U.S. Cl. CPC B60L 58/12; B60L 2200/40; B60L 2240/12; B60L 2240/545; B60L 2240/662; B60L 2260/52; B60L 2260/54

(57) ABSTRACT

The disclosure relates to a unit or a method for determining a remaining utilization capacity of at least one energy supply source connected to at least one electrical consumer used on a road construction machine, or a road construction machine, having at least one unit for determining a remaining utilization capacity. The unit is adapted to indicate a remaining utilization capacity determined on the basis of a current charging state of the energy supply source as a remaining utilization duration, a remaining utilization range and/or a remaining utilization area for the at least one consumer.

### CROSS REFERENCE TO RELATED APPLICATIONS

This application claims foreign priority benefits under 35 U.S.C. § 119 (a)-(d) to European patent application number EP 23181669.5, filed Jun. 27, 2023, which is incorporated herein by reference in its entirety.

### TECHNICAL FIELD

The present disclosure relates to a unit or a method for determining a remaining utilization capacity of at least one energy supply source connected to at least one electrical consumer used on a road construction machine, a road construction machine having at least one unit for determining a remaining utilization capacity or a paving train.

### BACKGROUND

Methods or devices for determining the charging state of an energy supply source for supplying an electrical consumer with energy are known from the prior art. The charging state is usually determined as the state of charge (SOC) and output to a receiver as a percentage. The disadvantage of the prior art is that the receiver may not recognize with sufficient accuracy whether the electrical consumer may completely carry out a predetermined work project with the charging state of the energy supply source.

Based on the known prior art, the technical problem to be solved is to specify a unit or a method for determining a remaining utilization capacity of at least one energy supply source connected to at least one electrical consumer used on a road construction machine, a road construction machine or a paving train, having at least one unit for determining a remaining utilization capacity, which enables the remaining utilization capacity to be determined and indicated simply and efficiently.

### SUMMARY

According to the disclosure, this object is solved by a unit for determining a remaining utilization capacity of at least one energy supply source connected to at least one electrical consumer used on a road construction machine according to claim 1, a road construction machine having at least one unit for determining a remaining utilization capacity according to claim 8, a paving train according to claim 13 or a method for determining a remaining utilization capacity of at least one energy supply source connected to at least one electrical consumer used on a road construction machine according to claim 14.

Advantageous further embodiments of the disclosure are covered in the depending claims.

One aspect of the disclosure relates to a unit for determining a remaining utilization capacity of at least one energy supply source connected to at least one electrical consumer used on a road construction machine. The unit is adapted for indicating the remaining utilization capacity determined on the basis of a current charging state of the energy supply source as remaining utilization duration, remaining utilization range and/or remaining utilization area for the at least one consumer. This enables simple and efficient determination and indication of the remaining utilization capacity of the energy supply source. Optionally, a user-friendly indication of the remaining utilization capacity may be achieved. Preferably, the acceptance of the unit by an operator of the unit may be increased.

The road construction machine may be, for example, a road paver, a feeder for a road paver, a roller vehicle or a milling vehicle. The energy supply source may be, for example, a battery, preferably a rechargeable battery.

In principle, the consumer may be any consumer required for the use of the road construction machine. On a road paver, for example, the consumer may be an electrically operated heating device, an electrically operated electro-hydraulic unit, an electrically operated longitudinal conveyor device, an electrically operated transverse conveyor device and/or an electrically operated undercarriage drive of the road paver. On a feeder, the consumer may be, for example, an electrically operated conveyor device for paving material, an electrically operated heating device and/or an electrically operated undercarriage drive of the feeder. On a roller vehicle, for example, the consumer may be an electrically operated roller drive and/or an electrically operated undercarriage drive of the roller vehicle. On a milling vehicle, the consumer may be, for example, an electrically operated longitudinal conveyor device, an electrically operated milling drive and/or an electrically operated undercarriage drive of the milling vehicle.

The energy supply source may be connected to only one or more consumers for energy supply. Optionally, the consumer may be connected to only one or more energy supply sources for energy supply. The unit may be adapted to indicate the current charging state of the energy supply source in addition to the remaining utilization capacity. The charging state of the energy supply source may, for example, be indicated as a percentage, e.g., as a state of charge (SOC), or as a bar graph. The remaining utilization duration may be determined and indicated in the unit hour and/or minute and/or second. The remaining utilization range may be determined and indicated in the unit kilometer and/or meter and/or centimeter. The remaining utilization area may be determined and indicated in the unit square meter. When determining the remaining utilization area, for example, a target working width of a paving layer to be produced or removed may be taken into account.

It would be conceivable that the determined remaining utilization area, in particular if it is indicated on a road paver, refers to the paving area that may still be produced depending on the charging state of the energy supply source. In an embodiment, in which the determined remaining utilization area may be indicated on a roller vehicle, the roller operator in particular may thus be shown the paving area that may still be compacted based on the charging state of an energy supply source installed in the roller vehicle, of the new paving layer laid in front of him in the paving direction.

The unit of the remaining utilization capacity may be set and/or changed manually, for example via a user interface, and/or automatically by the unit. For example, the operator of the road construction machine may individually determine in which unit the remaining utilization duration, the remaining utilization range and/or the remaining utilization area is indicated. For example, the operator may be a driver of the road construction machine and/or a screed operator of the road construction machine.

Preferably, the unit is adapted for indicating a target utilization capacity required for a planned work measure by means of the consumer as target utilization duration, target utilization range and/or target utilization area. Depending on the planned work measure by means of the consumer, a certain target utilization capacity may be required in order to successfully or completely carry out the work measure. For example, it may be planned as part of the work measure that the consumer is still to be used for a certain distance, a certain time period and/or a certain area to be paved or compacted in order to carry out the desired work measure. The advantage of this embodiment is that the operator may easily see at any time which target utilization capacity is required to carry out the work measure. Optionally, the decision of the operator whether the planned work measure may still be carried out with the remaining utilization capacity may be facilitated. In the best case, the reliability that the operator's assessment is correct may be increased. Optionally, scheduling and/or resource planning in connection with the work measure may be improved or facilitated. The target utilization duration may be determined and indicated in the unit hour and/or minute and/or second. The target utilization range may be determined and indicated in the unit kilometer and/or meter and/or centimeter. The target utilization area may be determined and indicated in the unit square meter. In particular, the target utilization area may be determined on the basis of a target working width and a target working length of a paving layer to be produced or removed, in particular to be milled off. The unit of the target utilization capacity may be determined and/or changed manually, for example via a user interface, and/or automatically. For example, an operator of the unit may individually select the unit in which the target utilization duration, target utilization range and/or target utilization area is indicated. This may increase the user-friendliness of the unit and optionally its acceptance by the operator.

Preferably, the determination of the remaining utilization capacity is based on current operating conditions of the electrical consumer, in particular a current and/or averaged energy demand of the electrical consumer. By means of this embodiment, the accuracy of the determination of the remaining utilization capacity may be improved. The energy demand may be recorded and averaged over a fixed or variable time period. The time period may be, for example, at least about three minutes, preferably at least about five minutes. The time period may be at most about 20 minutes, preferably at most about ten minutes. In particular, by determining the current energy demand, a possible defect of the electrical consumer may be determined, which may influence or reduce the remaining utilization capacity. The current operating conditions of the electrical consumer may be influenced by a current operating temperature of the consumer, a set rotational speed of a compaction unit, a set heating temperature of a heating device or a set conveying speed of a conveyor device of the road construction machine. The unit may be adapted to determine the current operating temperature of the consumer using a thermometer, for example an infrared thermometer or a surface thermometer. If the consumer is not currently in operation, for example, it cannot influence the current charging state of the energy supply source and can therefore have no influence on the remaining utilization capacity to be determined. If, on the other hand, the consumer is currently in operation, it may use some of the energy from the energy supply source depending on its current operating conditions, so that the current charging state of the energy supply source may change, in particular decrease. This allows the consumer to influence the remaining utilization capacity to be determined via its current operating conditions. By means of this embodiment, the accuracy of the determination of the remaining utilization capacity may be improved.

Preferably, the determination of the remaining utilization capacity is based on current working conditions of the energy supply source, in particular on a current working temperature of the energy supply source and/or a uniform or fluctuating load. Temperatures or load fluctuations of the energy supply source may lead to the fact that the energy stored in the energy supply source cannot be optimally utilized. Using this embodiment, the accuracy of determining the remaining utilization capacity may be improved. The current working temperature of the energy supply source may, for example, be measured using a thermometer, such as an infrared thermometer or a surface thermometer. The load on the energy supply source may be influenced by current and/or voltage peaks. The load may be uniform if the current and/or voltage peaks do not exceed and/or fall below a threshold value defined for the consumer.

Preferably, the determination of the remaining utilization capacity is based on a comparison of the current operating conditions of the electrical consumer with target operating conditions of the electrical consumer and/or the current working conditions of the energy supply source with target working conditions of the energy supply source. The target operating conditions of the consumer and/or the target working conditions of the energy supply source may originate from a manufacturing of the consumer or the energy supply source, for example a consumer or energy supply source data sheet. The target operating conditions of the electrical consumer may be a target rotational speed of a compaction unit, a target heating temperature of a heating device or a target conveying speed of a conveyor device of the road construction machine. The target working conditions of the energy supply source may be a target working temperature of the energy supply source and/or a uniform load of the energy supply source. The target operating conditions of the consumer and/or the target working conditions of the energy supply source may indicate conditions at which the consumer or the energy supply source operates ideally. The consumer may work ideally if the work result generated by it is optimally achieved. The energy supply source may work ideally when its capacity is at its highest. It may be desirable for the planned work measure to be carried out when the consumer and/or the energy supply source is operating approximately ideally.

If the current operating conditions deviate at least temporarily from the target operating conditions of the electrical consumer and/or if the current working conditions deviate at least temporarily from the target working conditions of the energy supply source, the actual remaining utilization capacity may be determined to be greater or less than the remaining utilization capacity that would be determined under the target operating conditions or target working conditions. According to one variant, it would be conceivable that the actual remaining utilization capacity, which may be indicated to the operator, results from the fact that a remaining utilization capacity calculated on the basis of target conditions is updated by a correction value that may be determined depending on the deviations detected by the target conditions. By means of this embodiment, it may be ensured that the remaining utilization capacity may be determined for the state in which the consumer and/or the energy supply source is actually operating. Ideally, the accuracy of determining the remaining utilization capacity may be increased.

Preferably, the unit is configured to correct the determined remaining utilization capacity based on the result of the comparison in order to determine a corrected, actual remaining utilization capacity. By means of this embodiment, the accuracy of the determination of the remaining utilization capacity may be increased or the determination of a falsified remaining utilization capacity may be avoided.

Preferably, the unit has at least one adjustable display field, for example a display, which may be used to show the remaining utilization capacity or the corrected remaining utilization capacity. This makes it easy for the operator to see the remaining utilization capacity. Ideally, the remaining utilization capacity may be displayed in a clear and/or user-friendly manner. Optionally, the user interface for setting and/or changing the unit of the remaining utilization capacity and/or the target utilization capacity may be integrated into the display field. The display field may be a touchscreen, for example. The display field may be set manually by the operator and/or automatically by the unit as desired. For example, the unit of the remaining utilization capacity and/or the target utilization capacity and/or the display field may be adjustable with respect to a brightness or a contrast of the display field and/or a size of the indication on the display field and/or a color of the indication and/or a font. The unit may optionally store one or more defined settings of the display field, for example operator-specific settings. This may allow the operator to easily and quickly select a saved setting. This may increase the user-friendliness of the unit and, ideally, its acceptance by the operator. Optionally or additionally, the remaining utilization capacity may be displayed acoustically, for example via a loudspeaker.

Preferably, the unit is configured to output a signal, in particular if the remaining utilization capacity or the corrected remaining utilization capacity is less than a predetermined percentage of the target utilization capacity. The percentage may be at least about 10%, preferably at least about 15%. The percentage may be at most about 50%, preferably at most about 30%. The signal may be visual and/or audible and/or tactile. This allows the operator to be indicated at a sufficiently early stage when the remaining utilization capacity falls below a certain percentage of the target utilization capacity. The operator may then take a respective measure if necessary. The measure may, for example, consist of a planned work measure not being carried out or only being carried out in part. The measure may optionally consist of setting one or more other consumers, which are not required for the planned work measure but are connected to the energy supply source in terms of energy, to an energy-saving mode or switching them off. Ideally, the user-friendliness of the unit and optionally its acceptance by the operator may be increased.

It would be conceivable for the unit to be configured as a transmitter in order to transmit a signal indicating the remaining utilization capacity to an remote receiver at least at intervals or continuously, for example to a station configured for a charging process of the energy supply source and/or for an exchange of the energy supply source, which is provided in particular in the form of a mobile device on a construction site. Together with the receiver, the unit may thus form a transceiver (transmitter-receiver) device that ideally ensures uninterrupted operation of the road construction machine, in particular uninterrupted operation of the consumer.

The disclosure further relates to a road construction machine having at least one unit for determining a remaining utilization capacity according to the disclosure. The advantages are the same as for the above-mentioned unit for determining the remaining utilization capacity. The unit may be mobile or permanently installed on the road construction machine. This means that the unit may be optimally integrated into the road construction machine or may be used flexibly. The unit may be arranged at a driver's control station and/or external control station of the road construction machine. For example, a driver may be located at the driver's control station and/or a screed operator at the external control station, who may thus easily access the unit.

Preferably, the unit is configured to transmit a remaining utilization capacity or a corrected remaining utilization capacity to at least one remote receiver. For this purpose, the unit may be connected wirelessly to the receiver. The receiver may, for example, be a remote computing and/or data storage unit that may store and/or evaluate the remaining utilization capacity over a determined time period. For example, the remaining utilization capacity of the energy supply source may be transmitted to the receiver in order to optimize processes associated with the road construction machine. This offers the advantage, for example, that one or more planned work measures in connection with the road construction machine may be controlled in an economically or strategically advantageous manner.

It would be conceivable for the consumer to be switched to an energy-saving mode, at least temporarily, based on the remaining utilization capacity sent, in order to ideally ensure uninterrupted operation. For this purpose, the unit could be configured as a transceiver in order to receive a request signal from the computing unit in response to a signal indicating the remaining utilization capacity sent to the computing unit, which may cause the unit to switch the consumer at least temporarily to energy-saving mode.

Preferably, the road construction machine is a road paver, a feeder for a road paver, a roller vehicle or a milling vehicle. The road paver may be configured for installing a paving layer. The feeder may be provided for supplying the road paver with paving material. This allows the remaining utilization capacity of the energy source to be easily and efficiently determined and indicated by a road paver or a feeder. The milling vehicle may be configured to remove, in particular mill off, an old paving layer. The roller vehicle may be configured to compact the new paving layer produced by the road paver to a predetermined degree of compaction. For this purpose, the roller vehicle may in particular perform repeated rolling movements on the new paving layer or at least an area thereof until the predetermined degree of compaction is reached. In particular for the roller vehicle, it may therefore be desirable to specify the target utilization capacity and/or the remaining utilization capacity as a target utilization area or as a remaining utilization area.

Preferably, the determination of the remaining utilization capacity is based on a current outside temperature of the road construction machine and/or a current driving speed of the road construction machine. The current outside temperature may indicate a temperature of the ambient air in the vicinity of the road construction machine. For example, the current outside temperature may be determined using a thermometer on or near the road construction machine. It would be useful if the unit is connected to a weather station installed on the road construction machine, in particular on the roof structure, in order to receive current weather conditions, in particular the current outside temperature, from the weather station. The current outside temperature may influence the current working temperature of the energy supply source and thus the determination of the remaining utilization capacity. The current driving speed of the road construction machine may influence current operating conditions of the electrical consumer, in particular an energy demand of the electrical consumer, and thus the determination of the remaining utilization capacity. By means of this embodiment, the accuracy of the determination of the remaining utilization capacity may be improved.

Preferably, the energy supply source is a battery and/or the consumer is an electrically operated heating device and/or the consumer is an electrically operated electro-hydraulic unit and/or the consumer is an electrically operated longitudinal conveyor device and/or the consumer is an electrically operated transverse conveyor device and/or an electrically operated undercarriage drive of the road construction machine, in particular of the road paver. Optionally, the consumer may be an electrically operated conveyor device for paving material, an electrically operated heating device and/or an electrically operated undercarriage drive of the feeder. Optionally, the consumer may be an electrically operated roller drive and/or an electrically operated undercarriage drive of the roller vehicle. Optionally, the consumer may be an electrically operated longitudinal conveyor device, an electrically operated milling drive and/or an electrically operated undercarriage drive of the milling vehicle.

It would be conceivable for the road construction machine, in particular the unit for determining the remaining utilization capacity, to be functionally connected to a material supply chain, for example via a web-based application, wherein a minimum paving material temperature for the paving material to be provided via the material supply chain of the road construction machine may be requested by means of the road construction machine depending on the remaining utilization capacity detected. By supplying a hotter paving material, the consumer may be switched at least temporarily to an energy-saving mode, for example a heating device of the road construction machine fed by the energy supply source, without this causing a change in the desired working or paving result of the road construction machine.

The disclosure also relates to a paving train comprising at least one road construction machine, in particular at least one feeder, at least one road paver and at least one roller vehicle, wherein in particular a remaining utilization capacity, in particular a remaining utilization area, is transmittable from the road paver and/or feeder to the roller vehicle. It would be conceivable that a remaining utilization capacity, in particular a remaining utilization area, is transmittable from the roller vehicle to the road paver and/or feeder.

Optionally, the paving train may also have a milling vehicle according to the disclosure, which may transmit the remaining utilization capacity, in particular the remaining utilization area, to the road paver, feeder and/or roller vehicle. When determining the remaining utilization area, a target working width of a paving layer to be removed may be taken into account.

In principle, the remaining utilization capacity between the components of the paving train, i.e., the road paver, feeder, roller vehicle and optionally milling vehicle, may be transmittable and, in particular, comparable. This ensures that the respective participants in the paving train are informed of each other's energy reserves and, in particular, that their operation may be adjusted depending on this. For example, it would be conceivable for a roller vehicle driver to reduce its rolling performance, in particular its rolling speed, knowing that a road paver ahead in the paving train in the paving direction is operating with a low energy storage charge level.

The remaining utilization capacity of the road construction machine in the paving train that is the smallest may be taken into account in the control system of the paving train, i.e., for coordinated operation of the road construction machines working in the paving train. For example, the remaining utilization capacities of all road construction machines in the paving train may be compared with each other, wherein, for example, the respective consumers of the road construction machines may be coordinated with each other in their operation.

The disclosure also relates to a method for determining a remaining utilization capacity of at least one energy supply source connected to at least one electrical consumer used on a road construction machine. In the method, a remaining utilization capacity is indicated as the remaining utilization duration, remaining utilization range and/or remaining utilization area for the at least one consumer on the basis of a detected, current charging state of the energy supply source.

Preferably, the unit is used to indicate a target utilization capacity required for a planned work measure by means of the consumer as target utilization duration, target utilization range and/or target utilization area. The same advantages arise as with the above-mentioned unit for determining a remaining utilization capacity or the road construction machine having at least one unit for determining a remaining utilization capacity.

Features or explanations described with regard to one of the aspects (unit, road construction machine or method) may be transferred to and combined with the other aspects.

### BRIEF DESCRIPTION OF THE DRAWINGS

The disclosure is explained in more detail below with reference to embodiments. It shows:

FIG. 1 shows a schematic representation of a road construction machine in the form of a road paver with a unit for determining a remaining utilization capacity according to an embodiment;

FIG. 2 shows a schematic representation of a road construction machine in the form of a feeder for a road paver with a unit for determining a remaining utilization capacity according to an embodiment;

FIG. 3 shows a perspective view of a region of the road paver from FIG. 1 according to an embodiment;

FIG. 4 shows a schematic view of a display field of a unit for determining a remaining utilization capacity of at least one energy supply source connected to at least one electrical consumer used on a road construction machine, according to an embodiment, and

FIG. 5 shows a schematic view of a display field of a unit for determining a remaining utilization capacity of at least one energy supply source connected to at least one electrical consumer used on a road construction machine, according to a further embodiment.

Identical technical components are provided with the same reference signs throughout the figures.

### DETAILED DESCRIPTION

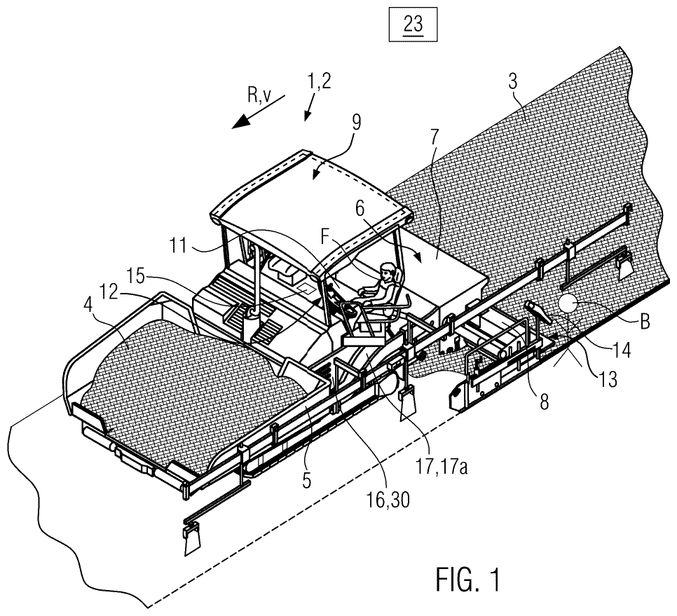

FIG. 1 shows a schematic representation of a road construction machine 1, which is configured as a road paver 2 for installing a new paving layer 3 with a target paving width or with a target working width and a target working length. The road paver 2 installs the new paving layer 3 in the travel direction R at a paving speed v of approximately 10 m/min. To do this, the road paver 2 uses paving material 4, which is stored in a hopper 5 adapted to the front of the paver. The paving material 4 stored in the hopper 5 is transported by means of a longitudinal conveyor 30 against the travel direction R to a screed 6, which is adapted to compact the paving material 4 presented to it to form the new paving layer 3.

The screed 6 shown in FIG. 1 is configured as an extending screed. The screed 6 has a base screed 7 and lateral extending parts 8 for setting the desired paving width of the new paving layer 3.

The road paver 2 of FIG. 1 comprises a driver's control station 9 for a driver F. A control panel 12 is provided for the driver F on the driver's control station 9 of the road paver 2. The control panel 12 is configured for controlling and monitoring processes that may be carried out by means of the road paver 2. For example, the driver F may set the speed v of the road paver 2 in the travel direction R on the control panel 12.

FIG. 1 also shows an external control station 13, which creates a workplace for a screed operator B on the outside of the screed 6 in order to control and monitor processes of the road paver 2, in particular the screed 6. A further control panel 14 is provided at the external control station 13 for this purpose.

The road paver 2 further has a battery 17a as energy supply source 17, which is connected to the longitudinal conveyor device 30 as electrical consumer 16 in order to supply it with energy.

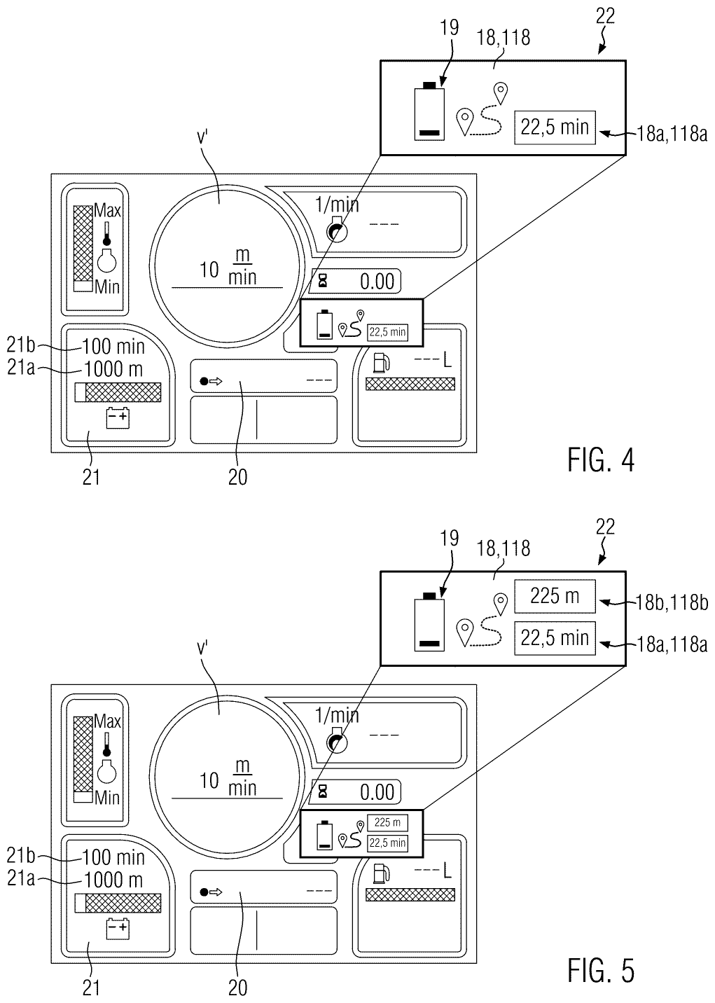

FIG. 1 also shows a unit 15 for determining a remaining utilization capacity 18 (see FIG. 4) of the battery 17a, which is explained in more detail below. The unit 15 is preferably arranged as a mobile unit on the driver's control station 9, so that the driver F may remove the unit 15 from the road paver 2 if necessary. For example, the unit 15 is part of an operating unit configured to control and monitor the processes running on the road paver 2. In that regard, as one skilled in the art would understand, the unit 15, as well an any other unit, controller, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such unit, controller, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

The unit 15 is further configured to transmit, preferably wirelessly, the remaining utilization capacity 18 to at least one remote receiver 23. For this purpose, the unit 15 is configured as a transmitter for preferably transmitting, at least at intervals, a signal indicating the remaining utilization capacity 18 to the remote receiver 23. According to this embodiment example, the remote receiver 23 is provided as a station configured for a charging process of the battery 17a, in particular as a mobile charging device, in the environment of the road paver 2. Together with the receiver 23, the unit 15 thus forms a transceiver (transmitter-receiver) device that ideally ensures uninterrupted operation of the road paver 2, in particular uninterrupted operation of the longitudinal conveyor device 30.

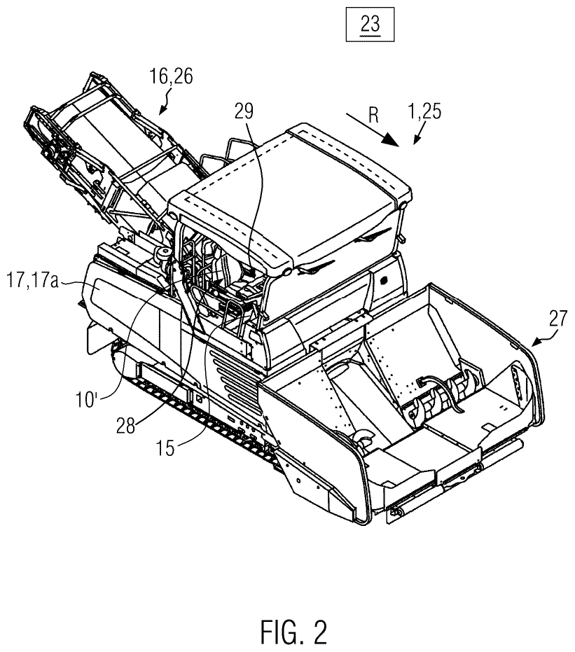

FIG. 2 shows another road construction machine 1 configured in the form of a feeder 25 for a road paver 2. Such a feeder 25 is used in practice to supply a road paver 2 as shown in FIG. 1 with paving material 4. For this purpose, the feeder 25 travels in front of the road paver 2 in the travel direction R and throws paving material 4 into the hopper 5 of the road paver 2 following it by means of a conveyor device 26 adapted to the feeder 25. The feeder 25 of FIG. 2 has a hopper 27 for receiving paving material 4. The conveyor device 26 extends as far as the hopper 27 and may thus transport the paving material 4 stored therein, against the travel direction R in the direction of the following road paver 2 and transfer it to the latter.

According to FIG. 2, the feeder 25 has a driver's control station 28. A seat console 10′ for the driver F′ and a control panel 29 for controlling and monitoring the processes carried out by the feeder 25 are mounted on the driver's control station 28.

The feeder 25 further has a battery 17a as energy supply source 17, which is connected to the conveyor 26 as electrical consumer 16 in order to supply it with energy.

FIG. 2 also shows a unit 15 for determining a not shown remaining utilization capacity 18 of the battery 17a, which is explained in more detail below. The unit 15 is preferably arranged as a mobile unit at the driver's control station 28, so that the driver F′ may remove the unit 15 from the feeder 25 if necessary.

The unit 15 is further configured to transmit, preferably wirelessly, the remaining utilization capacity 18 to at least one remote receiver 23. For this purpose, the unit 15 is configured as a transmitter for preferably transmitting, at least at intervals, a signal indicating the remaining utilization capacity 18 to the remote receiver 23. According to this embodiment example, the remote receiver 23 is provided as a station configured for a charging process of the battery 17a as a mobile device in the environment of the feeder 25. The unit 15 thus forms, together with the receiver 23, a transceiver (transmitter-receiver) device which ideally ensures uninterrupted operation of the feeder 25, in particular uninterrupted operation of the conveyor device 26.

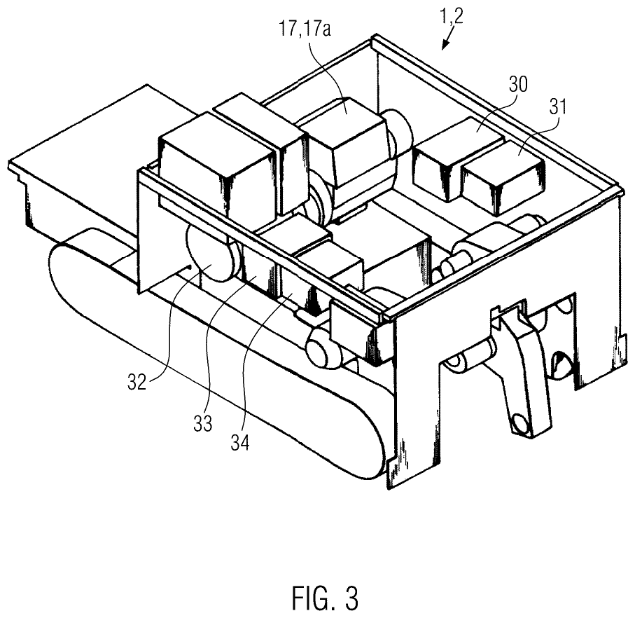

FIG. 3 shows a perspective view of a tractor unit of the road paver 2 of FIG. 1 according to an embodiment. FIG. 3 shows in detail that the battery 17a is installed in the road paver 2 as an energy supply source 17. In particular, the battery 17a may be present as an interchangeable module. At least one electrical consumer 16, in particular the electrically operated longitudinal conveyor device 30, an electrically operated heating device 31, an electrically operated electro-hydraulic unit 32, an electrically operated transverse conveyor device 33 and/or an electrically operated undercarriage drive 34 of the road paver 2 are provided at suitable points. The energy supply source 17 may also supply electrical current to other electrical consumers integrated in the towed screed 7, such as a heating device, which are not shown.

In the present embodiment example according to FIG. 3, all consumers 16 are electrically connected to the battery 17a. However, it is also conceivable to power only one or selected consumers 16 electrically via the battery 17a. Optionally, it is also conceivable to provide several energy supply sources 17, each of which is connected to only one or more consumers 16. It is also conceivable that one or more consumers 16 are connected to more than one energy supply source 17.

FIG. 3 illustrates, for example, the assembly of important electrical consumers 16 and their energetic connection with the battery 17a. The details of the type, number and assembly of the energy supply source 17 and the electrical consumers 16 are merely selected by way of example and do not limit the scope of protection. It is apparent to the person skilled in the art that for a feeder 25 as a road construction machine 1, the consumer 16 may also be another electrically operated device in addition to the electrically operated conveyor 26 for the paving material 4, for example an electrically operated heating device or an electrically operated undercarriage drive of the feeder 24. Optionally, the road construction machine 1 may be a roller vehicle 35 or a milling vehicle 36. The consumer 16 may then be an electrically operated roller drive and/or an electrically operated undercarriage drive of the roller vehicle 35, an electrically operated longitudinal conveyor device, an electrically operated milling drive and/or an electrically operated undercarriage drive of the milling vehicle 36.

FIGS. 4 and 5 each show a display field 22 of the unit 15 for a road construction machine 1 according to different embodiments. In the embodiment example, the display field 22 is provided on the road paver 2. It is apparent to the person skilled in the art that the display field 22 may also be provided on the feeder 25.

The unit 15 determines a current charging state 19 of the battery 17a as a state of charge (SOC) of approximately 15% and indicates this in the display field 22 in the form of a bar graph. This indication of the charging state 19 as a percentage may not be suitable for the driver F to estimate how far or how long the longitudinal conveyor device 30 and/or another electrical consumer 16 may still be operated with the battery 17a. In particular, it is not possible for the driver F to determine whether the energy stored in the energy supply source 17 is sufficient to complete a predetermined work measure 20, for example to install 50 tons of paving material with the current energy consumption, in view of the current operation.

The longitudinal conveyor device 30 is considered here purely by way of example as consumer 16. As stated, the consumer 16 may optionally be one or more of the consumers 16 shown in FIG. 3. For example, the consumer 16 may be an electrically operated heating device 31, an electrically operated electro-hydraulic unit 32, an electrically operated transverse conveyor device 33 and/or an electrically operated undercarriage drive 34 of the road paver 2. The details of the consumer 16 are selected by way of example only and do not limit the scope of protection.

In the embodiment example, it may be planned, for example, that the road paver 2 is to install a new paving layer 3 with a length of approximately 1000 m. A planned work measure 20 therefore consists, for example, of the battery 17a powering the electrically operated longitudinal conveyor 30 in such a way that the planned new paving layer 3 may be installed. In accordance with this work measure 20, a target utilization capacity 21 of the battery 17a in the form of a target utilization range 21a may be approximately 1000 m and/or in the form of a target utilization duration 21b may be approximately 100 min. The unit 15 is adapted to display the planned work measure 20 and/or the target utilization capacity 21 in the display field 22. Furthermore, the unit 15 is adapted for determining a remaining utilization capacity 18 of the battery 17a connected to the longitudinal conveyor device 30 for indicating whether the target utilization capacity 21 may be achieved therewith. The unit 15 is further adapted for indicating the remaining utilization capacity 18 determined on the basis of the current charging state 19 of the battery 17a as remaining utilization duration 18a, remaining utilization range 18b for the longitudinal conveyor device 30. Furthermore, the unit 15 may be adapted for determining and/or indicating a remaining utilization area 18c and/or a target utilization area 21c.

For determining the remaining utilization capacity 18, the unit 15 takes into account current operating conditions of the longitudinal conveyor device 30, in particular its average energy consumption, which is influenced by the set conveying speed of the longitudinal conveyor device 30. For this purpose, the energy demand of the longitudinal conveyor 30 is averaged over a period of approximately ten minutes and results in approximately 150 kWh for a conveying speed v′ of approximately 10 m/min. In addition, the determination of the remaining utilization capacity 18 is based on the current working conditions of the battery 17a, in particular its current working temperature, which is determined to be approximately 18° C. using an infrared thermometer. Based on this information, the unit 15 determines a remaining utilization capacity 18 as a remaining utilization duration 18a of approximately 25 minutes or a remaining utilization range 18b of approximately 250 m. In order to increase the accuracy of the determined remaining utilization capacity 18, the unit 15 compares the current operating conditions of the battery 17a with target operating conditions of the battery 17a and the current working conditions of the longitudinal conveyor device 30 with target working conditions of the longitudinal conveyor device 30. As target operating conditions of the battery 17a and as target working conditions of the longitudinal conveyor device 30, an energy consumption of approximately 100 kWh is stored in a consumer or energy supply source data sheet, for example at a conveyor speed of approximately 10 m/min, and a working temperature of the battery 17a of approximately 20° C. is stored. The unit therefore determines a deviation of approximately ten percent. Based on this result, the unit 15 corrects the remaining utilization capacity 18, so that a corrected remaining utilization duration 118a of approximately 22.5 minutes or a corrected remaining utilization range 118b of approximately 225 m results. Thus, the corrected remaining utilization capacity 118 of the battery 17a is approximately 22.5% of the target utilization capacity 21.

In FIG. 4, the display field 22 only shows the remaining utilization duration 18a or the corrected remaining utilization duration 118a of approximately 22.5 minutes as remaining utilization capacity 18 or as corrected remaining utilization capacity 118. The unit 15 is further configured to emit an acoustic signal via a loudspeaker arranged in the driver control station 9, not shown, if the corrected remaining utilization capacity 118 of the battery 17a is less than 30% of the target utilization capacity 21. In the embodiment example, the unit 15 therefore emits a signal as a warning. The driver F may take a respective measure, for example not to carry out the planned work measure.

In FIG. 5, the display field 22 of the unit 15 shows the current charging state 19 of the battery 17a of 15% as a bar graph. In addition, the display field 22 shows the respective corrected remaining utilization duration 118a of approximately 22.5 min. As stated, a target utilization capacity 21 of the battery 17a in the form of a target utilization range 21a of approximately 1000 m is required for the planned work measure 20. The driver F cannot easily estimate from the indicated corrected remaining utilization duration 118a whether the battery 17a may still supply the longitudinal conveyor device 30 with enough energy to carry out this work measure 20. Therefore, the display field 22 is controllable by means of a user interface, not shown, for setting and/or changing a unit of indicating the corrected remaining utilization capacity 118 to the display field 22. For this purpose, the display field 22 is adapted as a touch screen. The driver F may simply operate the touch screen with his fingers, so that the display field 22 displays the corrected remaining utilization range 118b of the battery 17a of 225 m in addition to the corrected remaining utilization duration 118a of 22.5 min. Optionally, it is also possible to set the display field 22 so that either the remaining utilization range 18b or the corrected remaining utilization range 118b or the remaining utilization duration 18a or the corrected remaining utilization duration 118a is indicated. It is quickly and easily apparent to the driver F that the corrected remaining utilization range 118b of 225 m of the battery 17a is no longer sufficient to carry out the planned work measure 20.

What is claimed is:

1. A unit for determining a remaining utilization capacity of at least one energy supply source connected to at least one electrical consumer used on a road construction machine wherein the unit is adapted for indicating the remaining utilization capacity determined on the basis of a current charging state of the at least one energy supply source as a remaining utilization duration, a remaining utilization range and/or a remaining utilization area for the at least one electrical consumer.

2. The unit according to claim 1, wherein the unit is adapted for indicating a target utilization capacity required for a planned work measure by the at least one electrical consumer as target utilization duration, target utilization range and/or target utilization area.

3. The unit according to claim 1, wherein the determination of the remaining utilization capacity is based on current operating conditions of the at least one electrical consumer, the current operation conditions comprising a current and/or averaged energy demand of the at least one electrical consumer.

4. The unit according to claim 2, wherein the determination of the remaining utilization capacity is based on current operating conditions of the at least one electrical consumer, the current operation conditions comprising a current and/or averaged energy demand of the at least one electrical consumer.

5. The unit according to claim 1, wherein the determination of the remaining utilization capacity is based on current working conditions of the at least one energy supply source, the current working conditions comprising a current working temperature of the at least one energy supply source and/or a uniform or fluctuating load.

6. The unit according to claim 3, wherein the determination of the remaining utilization capacity is based on a comparison of the current operating conditions of the at least one electrical consumer with target operating conditions of the at least one electrical consumer and/or the current working conditions of the at least one energy supply source with the target working conditions of the at least one energy supply source.

7. The unit according to claim 5, wherein the determination of the remaining utilization capacity is based on a comparison of the current operating conditions of the at least one electrical consumer with target operating conditions of the at least one electrical consumer and/or the current working conditions of the at least one energy supply source with the target working conditions of the at least one energy supply source.

8. The unit according to claim 7, wherein the unit is configured for correcting the determined remaining utilization capacity based on the result of the comparison to determine a corrected remaining utilization capacity.

9. The unit according to claim 6, wherein the unit is configured for correcting the determined remaining utilization capacity based on the result of the comparison to determine a corrected remaining utilization capacity.

10. The unit according to claim 1, wherein the unit has at least one adjustable display field, by which the remaining utilization capacity or the corrected remaining utilization capacity may be displayed, and/or the unit is configured to output a signal if the remaining utilization capacity or the corrected remaining utilization capacity is less than a predetermined percentage of the target utilization capacity.

11. A road construction machine, having at least one unit according to claim 1.

12. The road construction machine according to claim 11, wherein the unit is configured for transmitting a remaining utilization capacity or a corrected remaining utilization capacity to at least one remote receiver.

13. The road construction machine according to claim 11, wherein the road construction machine is a road paver, a feeder for a road paver, a roller vehicle or a milling vehicle.

14. The road construction machine according to claim 12, wherein the road construction machine is a road paver, a feeder for a road paver, a roller vehicle or a milling vehicle.

15. The road construction machine according to claim 11, wherein the determination of the remaining utilization capacity is based on a current outside temperature of the road construction machine and/or a current driving speed of the road construction machine.

16. The road construction machine according to claim 12, wherein the determination of the remaining utilization capacity is based on a current outside temperature of the road construction machine and/or a current driving speed of the road construction machine.

17. The road construction machine according to claim 11, wherein the at least one energy supply source is a battery and/or the at least one electrical consumer is an electrically operated heating device and/or the at least one electrical consumer is an electrically operated electro-hydraulic unit and/or the at least one electrical consumer is an electrically operated longitudinal conveyor device and/or the at least one electrical consumer is an electrically operated transverse conveyor device and/or an electrically operated undercarriage drive of the road construction machine.

18. A paving train comprising at least one road construction machine according to claim 10, wherein a remaining utilization capacity comprising a remaining utilization area, is transmittable from the road paver and/or feeder to the roller vehicle.

19. A method for determining a remaining utilization capacity of at least one energy supply source connected to at least one electrical consumer used on a road construction machine, the method comprising indicating the remaining utilization capacity as a remaining utilization duration, a remaining utilization range and/or a remaining utilization area for the at least one electrical consumer on the basis of a detected, current charging state of the at least one energy supply source.

20. The method according to claim 19, wherein by the unit, a target utilization capacity required for a planned work measure by the at least one electrical consumer is indicated as target utilization duration, target utilization range and/or target utilization area.
